(19) United States
(12) Patent Application Publication
(10) Pub. No.: US 2023/0135515 A1
(43) Pub. Date: May 4, 2023

(54) SOUND ABSORPTION DEVICE

(71) Applicant: Stéphane Demguilhem, Quinsac (FR)

(72) Inventor: Stéphane Demguilhem, Quinsac (FR)

(21) Appl. No.: 17/763,574

(22) PCT Filed: Sep. 25, 2020
(86) PCT No.: PCT/EP2020/076983

§ 371 Date: Oct. 31, 2022

(30) Foreign Application Priority Data
Sep. 25, 2019 (FR) FR1910592

(51) Int. Cl. G10K 11/162

(52) U.S. Cl. CPC G10K 11/162

(57) ABSTRACT

Sound absorption device for a noise-emitting area, said device comprising support means (10), attachment means (12) and sound absorption means (18), characterized in that the support means (10) comprise a support plane (16) on which said sound absorption means (18) are attached, directed toward said noise-emitting area

The invention relates to a sound absorption device.

In all living and working spaces, acoustic comfort is a very important parameter. Indeed, acoustic comfort plays an important role in concentration, fatigue, stress and intellectual performance. Any factor related to the acoustic quality of a space is therefore important to consider.

In buildings with poor sound insulation, the reverberation of different sounds can generate poor acoustics.

Collective workspaces or noisy spaces such as technical and industrial workshops can generate high sound levels, which are difficult to accept and uncomfortable, with values equal to or greater than 100 dB. For example, a metal building has no capacity to absorb noise and instead accentuates the reverberation of interior noises, forming an acoustic resonance volume.

Many materials and acoustic surfaces have been developed that, once placed on the walls, allow sound to be absorbed. This well-known solution is particularly used in music recording studios in order to avoid any reverberation and sound parasitism in order to obtain the best possible acoustic quality. These materials may also be applied to wall surfaces in cafeterias, schools or other noisy places. Covering wall surfaces with this type of acoustic coating may nevertheless be very expensive and is not suitable for industrial buildings or for certain applications, for example when the partitions are too far apart and the volumes are very large. Moreover, certain noises, generated intermittently, need to be insulated more locally. For example, the noise emitted in a noise-emitting area with a workstation on which noisy machines or tools are used, or restaurant tables, rather requires insulation applied in the direct vicinity of the noise source.

It would be useful to have an element that can be easily installed near sources of noise pollution and spaces that need to be insulated.

The present invention provides an acoustic device that can be suspended and placed above the noise source and that has a high sound absorption capacity. To this end, the sound absorption device for a noise-emitting area comprises support means, attachment means and sound absorption means and is characterized in that the support means comprise a support plane on which said sound absorption means are attached, directed toward said noise-emitting area.

The device allows the kinetic energy of the sound carried by the air molecules to be converted into mechanical energy by the fibers constituting the sound absorption means.

The support plane is a rigid support plane comprising a plurality of openings, each bar passing through an opening in the support plane.

In other words, the number of openings is equal to the number of sound absorption elements. The absorption elements extend longitudinally and vertically from a support plane and are aligned and spaced apart from one another along the plane comprising the support plane.

Advantageously, the device comprising support means, attachment means and sound absorption means and the support means comprise a support plane on which said sound absorption means are attached, directed toward said noise-emitting area.

Advantageously, the sound absorption means consist of at least one bar.

Each bar is at least partially formed by a material with a density between 12 kg/m3 and 24 kg/m3.

Advantageously, each bar is made of noise-absorbing foam or wadding.

Advantageously, the bars are of different sections, densities and lengths.

Advantageously, the length of each bar is increasingly shorter depending on whether the positioning of each bar is central. Thus, the bars placed on the periphery of the support plane are longer than the bars placed in the central part of the support plane, the length of said bars decreasing as one approaches the center of the absorption device,

Alternatively, the bars are organized into at least one bar alignment of a first material density and one bar alignment of a second material density. The bar alignments are spaced and positioned in staggered rows and the bars are staggered relative to one another so that a bar of a certain density is only aligned with another bar of the same density. The length of the bars is increasingly shorter depending on whether their positioning is central. Thus, the bars placed on the periphery of the absorption device are therefore longer than the bars placed in the central part of the support plane, the length of said bars decreasing as one approaches the center of the absorption device.

Advantageously, in the case of bars of different lengths, the lower ends of the bars of different lengths form a parabolic space, in particular open.

Advantageously, the support plane comprises at least one opening allowing the at least one bar to pass through said support plane, a pin maintaining each at least one bar on said support plane.

Advantageously, the upper end of the at least one bar is attached by gluing to the underside of the support plane.

Advantageously, in the case of several bars, the various bars are made of at least two materials.

Advantageously, the attachment means are formed by lines connected to the support plane.

As a variant, the attachment means may also be rigid with rods, for example in the case where the absorption device is directly fixed to the ceiling by clipping

The device comprises a member for adjusting the height of the support plane with respect to a noise-emitting area. In this way, it is possible to adjust the height of the device to adapt to the size of the noise-emitting area. If the user is working on a small noise-emitting area, the device can be brought closer to this area; on the contrary, if the user is working on a large object with a larger noise-emitting area, then the device can be remote from this area so as to cover a large noise-emitting area

The present invention is now described using examples, which are only illustrative and in no way limit the scope of the invention, and from the accompanying illustrations, wherein:

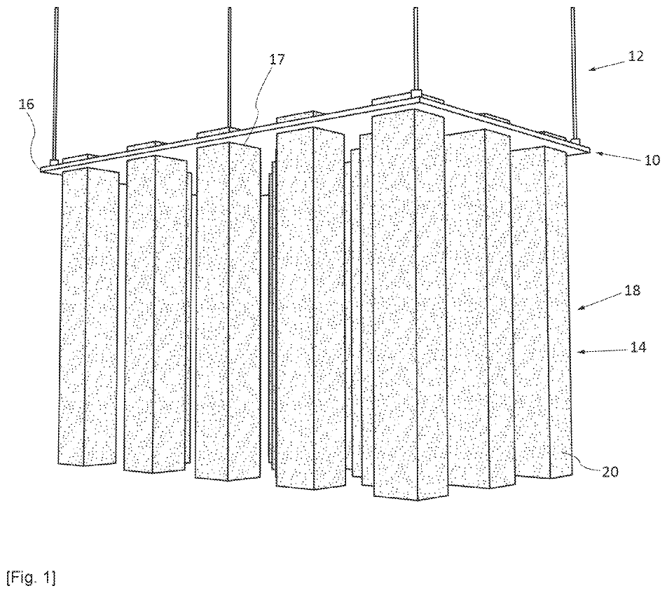

FIG. 1 shows a perspective view of the sound absorption device according to the invention.

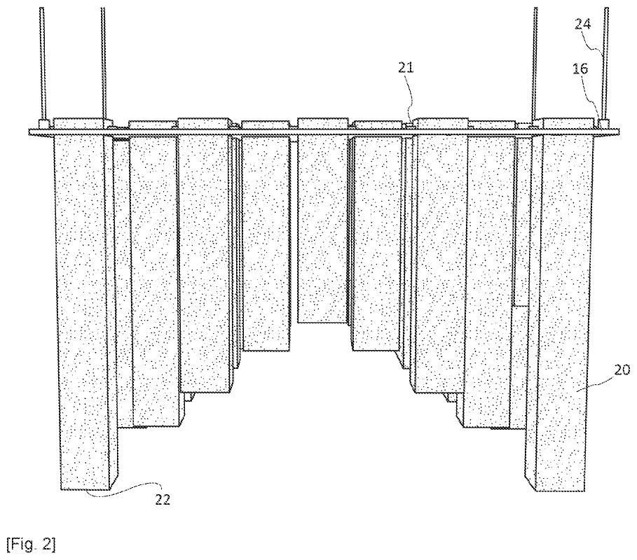

FIG. 2 shows a front view of the sound absorption device of FIG. 1.

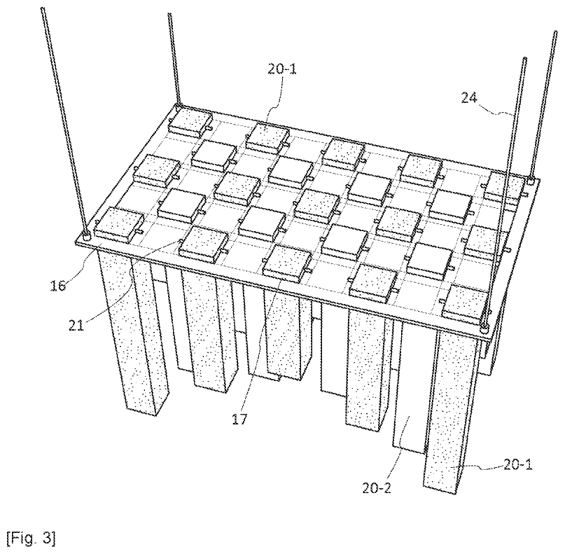

FIG. 3 shows a perspective top view of the sound absorption device according to the invention.

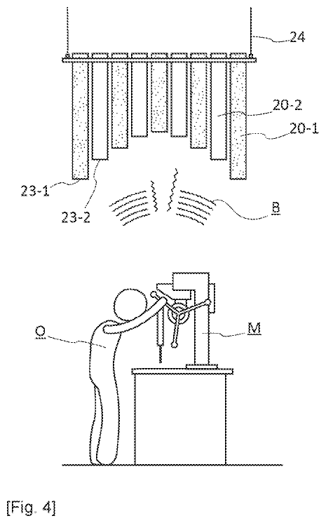

FIG. 4 shows a front view of an absorption device placed above a workstation.

The set of FIGS. 1 to 4 is considered in an orthogonal coordinate system X, Y and Z. The sound absorption device comprises support means 10, attachment means 12 and sound absorption means 14. The support means 10 are formed by a rigid support plane 16 comprising at least one opening 17 through which a sound absorption element 18 passes. The sound absorption element 18 is formed by bars 20. Each bar 20 passes through an opening 17 of the support plane 16 and is held vertically by a pin 21, formed by a shaft, that passes through said bars 20 along the plane X, Y and which are placed above the support plane 16. The pin 21 allows each bar 20 to be removed independently for easy cleaning or replacement thereof. The number of openings 17 is equal to the number of sound absorption elements 18. The sound absorption device therefore comprises at least one sound absorption element 18. In the configurations shown in FIGS. 1 to 4, twenty-three sound absorption elements 18 are placed through the openings 17 made in the support plane 16. The absorption elements 18 are made by bars 20 extended longitudinally and vertically from a support plane 16, along the Z axis. The bars 20 are distributed in an organized manner and are aligned and spaced apart from one another along the plane X, Y of the orthogonal coordinate system comprising the support plane 16. The bars 20 may be of identical length, but to increase the sound absorption performance, the bars 20 here have a different length, as shown in FIG. 2. This other arrangement describes a configuration in which the length of each bar 20 is increasingly shorter depending on whether the positioning of each bar 20 is central. Thus, the bars 20 placed on the periphery of the support plane 16 are longer than the bars 20 placed in the central part of the support plane 16, the length of said bars 20 decreasing as one approaches the center of the absorption device, in the plane X, Y. All of the lower ends 22 of the bars 20 thus together form a downwardly open parabolic space, if one considers a substantially parabolic surface that passes through the end of each bar 20.

The bars 20, described as being retained vertically by a pin 21, can also be glued by one of their ends, in this case the upper end. In the latter case, the bars 20 do not cross the support plane 16, but extend downward from said support plane 16, suspended.

In another arrangement, shown in FIGS. 3 and 4, the sound absorption device is provided with at least two types of bars 20-1 and 20-2. Said bars 20-1 and 20-2 are also held on the support plane 16 by pins 21. Each of said at least two types of bar 20-1 and 20-2 has a different length and/or density of material and/or is made of at least two materials. One arrangement is shown in FIG. 3, and comprises a bar alignment 20-1 of a first material density and a bar alignment 20-2 of a second material density. The material used here is wadding having high-performance sound qualities, but also environmental qualities so as to ensure in particular recycling or non-polluting destruction of this material, which has the advantage of not releasing volatile organic compounds. The bar alignments 20-1 and 20-2 are also spaced apart and staggered and the bars 20-1 and 20-2 are offset from one another so that a bar 20-1 of a certain density is only aligned with another bar 20-1 of the same density. The length of the bars 20-1 and 20-2 is increasingly shorter depending on whether their positioning is central. Thus, the bars 20-1 and 20-2 placed on the periphery of the absorption device are therefore longer than the bars 20-1 and 20-2 placed in the central part of the support plane 16, the length of said bars 20-1 and 20-2 decreasing as one approaches the center of the absorption device. The bars 20-1 and 20-2 each have an end 23-1 and 23-2, these ends together forming a downwardly open parabolic space. However, many combinations are possible. In another configuration that is not shown, the bars 20-1 and 20-2 may be of different geometry, of square, hexagonal, triangular section, or even be an irregular polygon. The bars 20-1 and 20-2 may also have the same or different density. The attachment means 12 are formed by lines 24 connected to the support plane 16 and which can be attached to a ceiling, beams or a specifically provided support, the weight of the device according to the invention having a large volume but a reduced weight. The attachment means may also be rigid with rods, in the case where the absorption device is directly fixed to the ceiling by clipping.

The bars 20 are formed by a material having high sound absorption performance, such as wadding here, and may also be formed from foam or any other light material with high sound absorption capacity, in particular with a density of between 12 kg/m3 and 24 kg/m3.

FIG. 4 shows the sound absorption device of FIG. 3, suspended using lines 24 above a workstation comprising a machine M used by an operator O. The noise B from the noise-emitting area, represented by waves, propagates toward the operator O and upward, therefore toward the ceiling where the noise is damped, which protects the adjacent volume spaces and the people located there.

The implementation of the absorption device of the present invention is now described. The sound absorption device is intended to be hung or suspended in order to be positioned above and as close as possible to a noise source. It is therefore advantageous to position the sound insulation device as close as possible to the noise source. A workshop station where manual work with impacts is done generates noises of very different natures and frequencies. It is therefore advantageous to be able to have an absorption device capable of absorbing and attenuating these various sounds as well as possible. The sound absorption device described here proposes to maximize the attenuation of these different sounds by using an arrangement of at least two bars 20-1 and 20-2, of different natures and different lengths. Installing bars 20-1 and 20-2 of different densities therefore allows the attenuation of sounds of different frequencies because each density of absorbent material has a certain capacity to absorb a certain range of frequencies of the noise emitted and thus to improve the quality of the acoustic environment. Positioning the sound absorption device above the operator's station O and the machine M, given as an example to illustrate a noise source with multiple frequency spectra, allows the capture of a very large part of the noise B generated. The lines 24 allow the desired positioning in terms of height to ensure the best absorption. The noises composed of different powers and frequencies are then picked up by at least two types of bars 20-1 and 20-2, which, by virtue of their different densities, each pick up different frequency spectra. It is therefore possible to choose at least two types of bars according to the different noises generated, i.e. high-pitched, low-pitched, of different intensities and sound frequencies.

The installation of absorption devices can be multiplied and developed to measure according to the different activities and the different types of disturbance.

1. Sound absorption device for a noise-emitting area, said device comprising support means (10), attachment means (12) and sound absorption means (18), characterized in that:
the support means (10) comprise a support plane (16) on which said sound absorption means (18) are attached, directed toward said noise-emitting area
the sound absorption means (18) consist of at least one bar (20), each bar (20) being made of noise-absorbing foam or wadding, the bars (20) are of different sections, densities, lengths, in the case of bars (20) of different lengths, the lower ends (22) of the bars (20) of different lengths form an open parabolic space.

2. Sound absorption device according to one of claims 2 to 5, characterized in that the support plane (16) comprises at least one opening (17) allowing the at least one bar (20) to pass through said support plane (16), a pin (21) maintaining each at least one bar on said support plane (16).

3. Sound absorption device according to one of claims 2 to 5, characterized in that the upper end of the at least one bar (20) is attached by gluing to the underside of the support plane (16).

4. Device according to one of claims 2 to 7, characterized in that, in the case of several bars, the various bars (20) are made of at least two materials.

5. Sound absorption device according to one of the preceding claims, characterized in that the attachment means (12) are formed by lines (24) connected to the support plane (16).
